(19) United States
(12) Patent Application Publication
(10) Pub. No.: US 2024/0043292 A1
(43) Pub. Date: Feb. 8, 2024

(54) ELECTROCHEMICAL DESTRUCTION OF PERFLUORO COMPOUNDS

(71) Applicant: Ionic Water Technologies, LLC, Hamilton, NJ (US)

(72) Inventor: George W. ADAMSON, Hamilton, NJ (US)

(21) Appl. No.: 18/258,325

(22) PCT Filed: Dec. 21, 2021
(86) PCT No.: PCT/US2021/064525

§ 371 Date: Jun. 19, 2023

Related U.S. Application Data
(60) Provisional application No. 63/129,001, filed on Dec. 22, 2020.

(51) Int. Cl. C02F 1/461; C02F 1/467

(52) U.S. Cl. CPC C02F 1/46109; C02F 1/4672; C02F 1/4676; C02F 2101/36

(57) ABSTRACT

Described herein is an assembly, system and method for electrochemical destruction of perfluoro compounds such as PFOS, PFNA and PFOA, or other oxidizable or reducible compounds. Methods include flowing an aqueous liquid comprising a perfluoro compound into a vessel that houses a bipolar electrode assembly, the bipolar electrode assembly comprising a first electrode stack and second electrode stack, the first electrode stack comprising a first plurality of electrodes and the second electrode stack comprising a second plurality of electrodes, wherein the electrodes span laterally across at least a portion of the vessel, and wherein the electrodes define the boundaries of a tortuous path through the vessel; flowing the aqueous liquid through the vessel via the tortuous path; and applying a voltage to the bipolar electrode assembly while the aqueous liquid flows through the tortuous path to destroy the perfluoro compound.

### CROSS-REFERENCE TO RELATED APPLICATION

This application claims priority to U.S. provisional application No. 63/129,001 filed Dec. 22, 2020, the entire contents of which are incorporated herein by reference.

### TECHNICAL FIELD

The present invention relates to an assembly, system and method for electrochemical destruction of perfluoro compounds such as PFOS, PFNA and PFOA, or other oxidizable or reducible contaminants.

### BACKGROUND

This section provides background information related to the present disclosure and is not necessarily prior art.

The concentration and destruction of perfluoro compounds (e.g., PFOS, PFNA, PFOA) found as contaminants in many water sources on earth is of increasing importance given their deleterious health effects. Previous approaches have suffered from serious shortcomings including unsafe disposal of decomposition products, slow destruction rate, short life span and instability of electrode materials, incomplete destruction, noxious or hazardous gas generation, energy inefficiency, and electrode material cost. Thus, there is a need for safe, effective, and efficient electrochemical destruction systems and methods. There is also a particular need for destruction of perfluoro compounds when mixed with other organic contaminants or when concentrated with inorganic salts.

### SUMMARY

The present disclosure provides a destruction assembly for destroying an oxidizable or reducible compound, comprising a vessel that houses a bipolar electrode assembly, the bipolar electrode assembly comprising a first electrode stack and second electrode stack, the first electrode stack comprising a first plurality of electrodes and the second electrode stack comprising a second plurality of electrodes, wherein the electrodes span laterally across at least a portion of the vessel, and wherein the electrodes define the boundaries of a tortuous path through the vessel.

In some embodiments, the bipolar electrode assembly comprises metal electrodes comprising a metal selected from titanium, aluminum, steel, low-chromium steel, cast-iron, nickel, cobalt, chromium, or any alloy thereof. In some embodiments, the bipolar electrode assembly comprises ceramic electrodes. In some embodiments, the bipolar electrode assembly comprises glassy carbon electrodes.

In some embodiments, the bipolar electrode assembly comprises electrodes coated with titanium carbide, a titanium-carbon solid solution or suspension, titanium carbonitride, titanium oxycarbide, titanium oxynitride or titanium carbo-hydride. In some embodiments, the bipolar electrode assembly comprises electrodes coated with titanium carbide. In some embodiments, the titanium carbide has a Ti:C ratio of less than 2:1.

In some embodiments, the coating is from about 1 to about 100 microns thick.

In some embodiments, at least a portion of the bipolar electrode assembly is coated with a catalytic coating. In some embodiments, the catalytic coating comprises a mixed metal oxide or transition metal. In some embodiments, the catalytic coating comprises manganese or any oxide thereof, silver or any oxide thereof, or a mixed silver-copper oxide.

In some embodiments, the electrodes are rigid plates.

In some embodiments, first electrode stack and second electrode stack each comprise at least three electrodes.

In some embodiments, the electrodes extend laterally across the vessel and are perforated in an offset and alternating manner. In some embodiments, the electrodes extend from a wall of the vessel laterally more than half-way across the vessel.

In some embodiments, the first plurality of electrodes extend from a first wall of the vessel laterally more than half-way across the vessel and the second plurality of electrodes extend from a second wall of the vessel laterally more than half-way across the vessel and are offset from and alternate with the first plurality of electrodes to define the boundaries of a tortuous path through the vessel.

In some embodiments, the first plurality of electrodes is oriented substantially parallel to the second plurality of electrodes.

In some embodiments, the assembly further includes a central support member extending longitudinally through the inside of the vessel, wherein the first plurality of electrodes are joined to and supported by a vessel wall and the second plurality of electrodes are joined to and supported by the central support member.

In some embodiments, the first plurality of electrodes extend laterally inward from a wall of the vessel toward the central support member and the second plurality of electrodes extend laterally outward from the central support member.

In some embodiments, the vessel has a rectangular cross section and the electrodes are rectangle-shaped. In some embodiments, the vessel has a round cross section and the electrodes are disc-shaped.

The present disclosure also provides a destruction system for destroying an oxidizable or reducible compound comprising a destruction assembly and a power source electrically connected to the bipolar electrode assembly and configured to apply a voltage to the bipolar electrode assembly.

In some embodiments, the power source is directly electrically connected to the end electrodes of the bipolar electrode assembly.

The present disclosure also provides a method for destroying an oxidizable or reducible compound comprising: flowing an aqueous liquid comprising an oxidizable or reducible compound into a vessel that houses a bipolar electrode assembly, the bipolar electrode assembly comprising a first electrode stack and second electrode stack, the first electrode stack comprising a first plurality of electrodes and the second electrode stack comprising a second plurality of electrodes, wherein the electrodes span laterally across at least a portion of the vessel, and wherein the electrodes define the boundaries of a tortuous path through the vessel; flowing the aqueous liquid through the vessel via the tortuous path; and applying a voltage to the bipolar electrode assembly while the aqueous liquid flows through the tortuous path to destroy the oxidizable or reducible compound.

In some embodiments, the aqueous liquid further comprises a counter ion that is bound to the oxidizable or reducible compound. In some embodiments, the counter ion is a cation selected from Ca²⁺, Mg²⁺, Zn²⁺, Sr²⁺, Al³⁺, B³⁺, or Fe³⁺. In some embodiments, the counter ion is Ca²⁺.

In some embodiments, the aqueous liquid comprises calcium hydroxide.

In some embodiments, the aqueous liquid comprises a chloride, hydroxide or sulfate of Ca²⁺, Mg²⁺, Zn²⁺, Sr²⁺, Al³⁺, B³⁺, or Fe³⁺.

In some embodiments, the counter ion is an anion selected from a phosphate, a sulfate, or a borate.

In some embodiments, the aqueous liquid further comprises ozone.

In some embodiments, the method further includes applying a voltage of from about 90 V to about 120 V to the bipolar electrode assembly.

In some embodiments, the oxidizable or reducible compound is a perfluoro compound. In some embodiments, the perfluoro compound is destructively oxidized and/or destructively reduced to produce fluorine containing fragments. In some embodiments, the perfluoro compound is PFOS, PFNA, PFOA, or a conjugate base thereof.

In some embodiments, the fluorine containing fragments form insoluble salts with a counter ion present in the aqueous liquid. In some embodiments, the fluorine containing fragments form insoluble salts with calcium ions present in the aqueous liquid.

In some embodiments, the voltage is applied directly to end plates of the bipolar electrode assembly. In some embodiments, the voltage applied directly to the end plates of the bipolar electrode assembly is isolated from ground.

In some embodiments, the oxidizable or reducible compound is an organic compound, inorganic compound, or ion thereof. In some embodiments, the oxidizable or reducible compound is kerosene, toluene, or methyl tert-butyl ether (MTBE). In some embodiments, the oxidizable or reducible compound is a borate, a phosphate, a polyphosphate, a sulfate, an organic acid, a fatty acid, a humic substance, a short chain PFAS, a water-soluble medication, a detergent, a water-soluble insecticide, a water-soluble fungicide, or a water-soluble germicide.

In some embodiments, the aqueous liquid comprises a perfluoro compound and a second oxidizable or reducible compound, and wherein both the perfluoro compound and the second oxidizable or reducible compound are destroyed. In some embodiments, the second oxidizable or reducible compound is a fabric dye, a pharmaceutical, or a petrochemical.

Other features and advantages of the invention will be apparent from the following detailed description, figures, and from the claims.

### BRIEF DESCRIPTION OF THE FIGURES

The following figures are provided by way of example and are not intended to limit the scope of the claimed invention.

FIGS. 1A and 1B are schematics of an electrochemical destruction assembly having rectangular cross-section according to an embodiment of the present invention.

FIGS. 2A and 2B are schematics of an electrochemical destruction assembly having round cross-section according to another embodiment of the present invention.

FIG. 3 is a schematic of an electrochemical destruction assembly having canted electrodes according to another embodiment of the present invention.

FIGS. 4A and 4B are schematics of an electrochemical destruction assembly having a round cross-section and a central support member according to another embodiment of the present invention.

FIGS. 5A and 5B are schematics of an electrochemical destruction assembly having a rectangular cross-section and a central support member according to another embodiment of the present invention.

### DETAILED DESCRIPTION

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The terms, upper, lower, above, beneath, right, left, etc. may be used herein to describe the position of various elements with relation to other elements. These terms represent the position of elements in an example configuration. However, it will be apparent to one skilled in the art that the frame member may be rotated in space without departing from the present disclosure and thus, these terms should not be used to limit the scope of the present disclosure.

As used herein, when an element or coating is referred to as being “on,” “engaged to,” “connected to,” “attached to,” “joined to,” or “coupled to” another element or coating, it may be directly on, engaged, connected, attached, joined, or coupled to the other element or coating, or intervening elements or coatings may be present. In contrast, when an element or coating is referred to as being “directly on,” “directly engaged to,” “directly connected to,” “directly attached to,” “directly joined to,” or “directly coupled to” another element or coating, there may be no intervening elements or layers present. Other words used to describe the relationship between elements should be interpreted in a like fashion (e.g., “between” versus “directly between,” “adjacent” versus “directly adjacent,” etc.).

As used herein, the term “and/or” includes any and all combinations of one or more of the associated listed items.

As used herein, the term “anion” refers to any chemical entity or species having one or more negative charges. Examples of anions include, but are not limited to, fluoride, chloride, bromide, iodide, arsenate, phosphate, arsenite, hydrogen phosphate, dihydrogen phosphate, sulfate, nitrate, hydrogen sulfate, nitrite, thiosulfate, sulfite, perchlorate, iodate, chlorate, bromate, chlorite, hypochlorite, hypobromite, carbonate, chromate, hydrogen carbonate (bicarbonate), dichromate, acetate, formate, octanoate, cyanide, amide, cyanate, peroxide, thiocyanate, oxalate, hydroxide, and permanganate.

As used herein, the term “cation” refers to any chemical entity or species having one or more positive charges. Examples of cations include, but are not limited to, hydrogen, lithium, sodium, potassium, cesium, silver, magnesium, calcium, strontium, barium, zinc, cadmium, aluminum, ammonium, hydronium, chromous, chromic, manganous, ferrous, ferric, cobaltous, cobaltic, nickelous, nickelic, cuprous, atannous, atannic, plumbous, and plumbic.

As used herein, the term “alloy” refers to a homogenous mixture or solid solution produced by combining two or more metals, for example, to give greater strength or resistance to corrosion. Examples of alloys include, but are not limited to, stainless steel (e.g., 332 stainless steel, 316 stainless steel), carbon steel, or alloys of: gold, silver, copper, aluminum, nickel, palladium, platinum, titanium, aluminum, cobalt, or chromium, either with each other or with other metals.

As used herein, the term “hydroxide” refers to both ionic compounds that contain a hydroxide ion and covalent compounds that contain a hydroxy group.

As used herein, the term “oxide” refers to compounds that contain at least one oxygen atom and at least one other atom. Examples of oxides include, but are not limited to, titanium oxides, aluminum oxides, copper oxides, silver oxides, and manganese oxides, as well as mixed metal oxides.

As used herein, the term “perfluoro compound” refers to organic compounds wherein some or all C—H bonds are replaced by C—F bonds, including, but not limited to, the following substances: perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, perfluorotetradecanoic acid, perfluorohexadecanoic acid, perfluorooctadecanoic acid, perfluorobutanesulfonic acid, perfluoropentanesulfonic acid, perfluorohexanesulfonic acid, perfluorooctanesulfonic acid, perfluorononanesulfonic acid, perfluorodecanesulfonic acid, perfluorododecanesulfonic acid, perfluorooctanesulfonamide, N-methylperfluoro-1-octanesulfonamide, N-ethylperfluoro-1-octanesulfonamide, 1H,1H,2H,2H-perfluorohexanesulfonic acid (4:2), 1H,1H,2H,2H-perfluorooctanesulfonic acid (6:2), 1H,1H,2H,2H-perfluorodecanesulfonic acid (8:2), 1H,1H,2H,2H-perfluorododecanesulfonic acid (10:2), N-methyl perfluorooctanesulfonamidoacetic acid, N-ethyl perfluorooctanesulfonamidoacetic acid, 2-(N-methylperfluoro-1-octanesulfonamido)-ethanol, 2-(N-ethylperfluoro-1-octanesulfonamido)-ethanol, tetraluoro-2-(heptafluoropropoxy)propanoic acid (“GenX”), 4,8-dioxa-3H-perfluorononanoic acid, 11-chloroeicosafluoro-3-oxaundecane-1-sulfonic acid, and 9-chlorohexadecafluoro-2-oxanone-1-sulfonic acid, or a conjugate base of any of these acids. A perfluoro compound may be bound to a counter ion, or other precipitating agent.

“PFOS” refers to perfluorooctanesulfonic acid.

“PFOA” refers to perfluorooctanoic acid.

“PFNA” refers to perfluorononanoic acid.

As used herein, “destroy” or “destruction” refers to breaking of covalent bonds in a perfluoro compound or other oxidizable or reducible compound to create fragment compounds.

### II. Electrochemical Destruction Assembly and System

In one aspect, provided herein is an assembly for destruction of an oxidizable or reducible compound. In some embodiments, the oxidizable or reducible compound is a perfluoro compound. The oxidizable or reducible compound (e.g., perfluoro compound) may be present in an aqueous liquid. The destruction assembly and system of the present application are useful for destroying such contaminants present in an aqueous liquid when the aqueous liquid is flowed through the assembly.

The destruction assembly comprises a vessel that houses a bipolar electrode assembly. The vessel may be a column, pipe, tank, or the like. In some embodiments, the vessel is made from an insulating (non-conductive) material, or has an inner surface made from an insulating material. The electrodes of the bipolar electrode assembly may be joined to and/or supported by the vessel.

The bipolar electrode assembly comprises a first electrode stack and second electrode stack. The first electrode stack comprises a first plurality of electrodes and the second electrode stack comprises a second plurality of electrodes. The electrodes span laterally across at least a portion of the vessel and define the boundaries of a tortuous path (e.g. zig-zag path) through the vessel. In some embodiments, each electrode of an electrode stack is oriented substantially parallel with each of the other electrodes of the stack. In some embodiments, the electrodes of the first electrode stack and the second electrode stack alternate along the longitudinal direction of the vessel. In some embodiments, the electrodes are rigid plates. In some embodiments, the electrodes extend across the vessel and are perforated in an offset manner wherein each electrode of the first electrode stack is perforated at or near a first lateral side of the vessel, and each electrode of the second electrode stack is perforated at or near a second, opposite lateral side of the vessel. In some embodiments, the first and second electrode stacks each comprise at least 3, at least 5, at least 10, at least 20, or at least 50 electrodes.

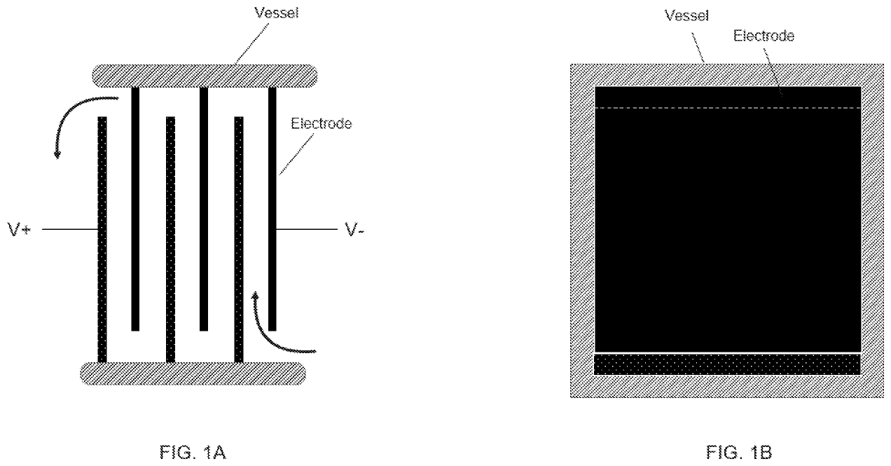

FIG. 1A shows a schematic of an electrochemical destruction assembly (100) according to an embodiment of the present invention. In this embodiment, at the top and bottom are shown a cross section of the walls of a vessel (102). The electrodes (104) extend from the vessel (102) walls across a lateral direction of the vessel. Three electrodes extending from the bottom wall define a first electrode stack. Three electrodes extending from the top wall define a second electrode stack that is offset from and alternates with the first electrode stack. The electrodes extend more than half-way across the vessel but do not touch (i.e., leave a gap at) the other side of the vessel. The electrodes extend substantially perpendicular from the vessel wall at their point of contact with the vessel. The electrodes within the each stack are substantially parallel with each other and also are substantially parallel with the electrodes in the other stack. The electrodes of the first electrode stack and second electrode stack are offset and alternating so as to define a tortuous path, e.g., a zig-zag path, for liquids to flow longitudinally through the vessel. A liquid flow path is shown with arrows. The electrodes span the vessel such that in order for liquid to flow through the vessel, liquid is forced to flow along the length of the electrode until it reaches the end of the electrode (i.e., liquid cannot flow around the sides of the electrode, only the one end).

Referring to the embodiment of FIG. 1B, the vessel (102) has a rectangular cross-section with rectangle-shaped plate electrodes (104) that span across the vessel (102). Liquid flows across the electrode plate and over the electrode edge (bottom solid line) onto the next adjacent electrode of the bipolar electrode assembly. Liquid then flows back in the opposite direction and over the next electrode edge (shown schematically as top dashed line) onto the next adjacent electrode of the bipolar electrode assembly.

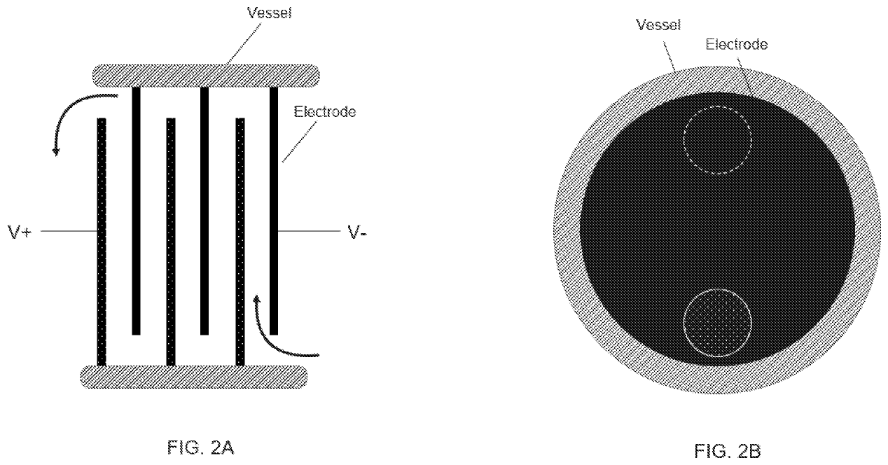

Referring to FIGS. 2A and 2B, a round or circular cross-section embodiment of a destruction assembly (200) is illustrated with perforated disc plates. Schematically, as shown in FIG. 2A, this embodiment operates similarly to FIG. 1A. As shown in FIG. 2B, this embodiment has a round or circular cross section with round vessel (202) and disc-shaped electrodes (204). The electrodes are perforated with holes in an offset, alternating matter. The first electrode has a hole shown by the solid-lined circle at the bottom of the disc. Liquid flows over the first electrode and through the hole. Liquid then flows back across the adjacent electrode of the assembly, which also has a hole shown schematically as the dashed-lined circle at the top of the disc. The holes of the adjacent electrodes are offset, thereby creating a tortuous path through the vessel. In this embodiment, the electrodes span fully from edge to edge of the vessel but are perforated with holes to allow liquid to flow past the electrodes and through the vessel.

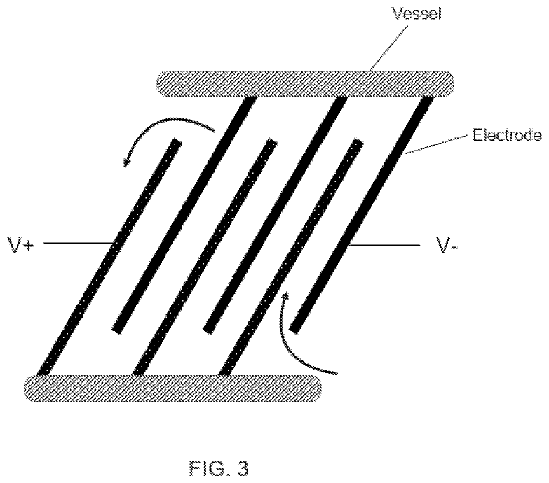

Referring to FIG. 3, another embodiment of a destruction assembly (300) is shown with canted electrodes (304). The electrodes (304) extend from the inner wall of the vessel (302) at an angle other than 90 degrees, e.g., 30 or 60 degrees. In this embodiment, the electrodes of each stack remain parallel to each other and to the electrodes of the other stack.

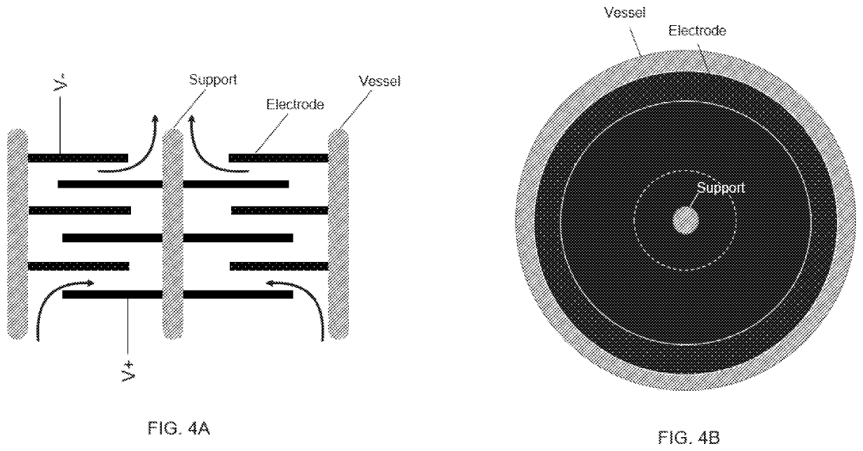

FIGS. 4A and 4B show yet another embodiment of a destruction assembly (400) according to the present invention. In this embodiment, the vessel (402) further includes a center support member (406) with the electrodes (404) supported on the vessel (402) and on the support member (406). The central support member extends longitudinally through the vessel and is positioned at or near the central longitudinal axis of the vessel. The first electrode stack is supported by the vessel wall and has donut-shaped electrodes that are joined to the vessel wall. The donut-shaped electrodes have a hole in the center (shown schematically by dashed circle of FIG. 4B) that allows liquid to flow past the electrodes and through the vessel. The second electrode stack is supported by the center support member. The electrodes of the second electrode stack extend out radially from the center support member toward the vessel wall but leave a gap near the vessel wall for liquid to flow past.

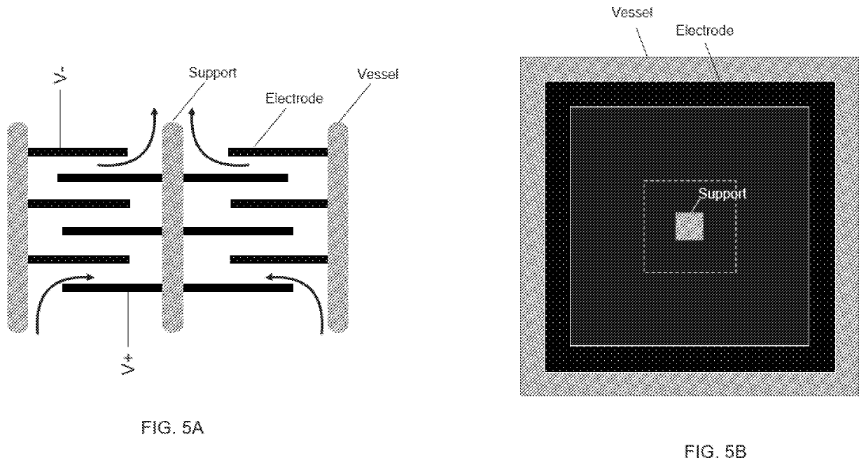

FIGS. 5A and 5B show another embodiment of a destruction assembly (500) with similar schematic design to FIGS. 4A and 4B but with a rectangular cross section. The first set of electrodes (504) are supported by the walls of the vessel (502) and have a hole at the center (shown schematically by dashed rectangle of FIG. 4B) that allows liquid to flow past. The second set of electrodes (504) are supported by the center support member (506) and extend outward toward the vessel walls, leaving a gap near the vessel walls for liquid to flow past.

A system of the present invention further comprises a power source electrically connected to the bipolar electrode assembly and configured to apply a voltage to the electrode assembly. Referring again to FIG. 1A, connection of the power source and application of the voltage is shown schematically as V+ and V−. This is also shown for FIGS. 2A, 3, 4A and 5A. The voltage may be a direct current (DC) voltage or an alternating current (AC) voltage. The polarity may also be the opposite of what is shown in FIG. 1A (or FIG. 2A, 3, 4A or but with the same liquid flow direction.

The power source is connected, and voltage is applied, at the opposite end electrodes, e.g., end plates, of the first and second electrode stacks, i.e., at the end plate of the first electrode stack near a first longitudinal end of the vessel and the end plate of the second electrode stack near a second, opposite longitudinal end of the vessel. Each electrode, e.g., each electrode plate, is insulated from the other electrode plates of the stack. Still referring to FIG. 1A, a voltage is applied to the end electrodes. The voltage is distributed through the bipolar electrode stack and the electrode plates in between divide the voltage. The total voltage V is (n−1) where n is the number of plates. In other words, the voltage between each pair of electrode plates is V/(n−1). While the aqueous liquid flows a tortuous (e.g., zig-zag) path through the vessel, the current from the power source follows a straight path through the vessel.

The electrodes of the bipolar electrode assembly are made from suitable conductive materials. Chemically stable electrodes configured into bipolar electrode assemblies allow for higher voltages, which leads to increased destruction rates. The electrodes can be ceramic electrodes or metal electrodes (e.g., titanium, aluminum, steel, low-chromium steel, cast-iron, nickel, cobalt, chromium, or any alloy thereof). In some embodiments, the ceramic electrode is formed from ceramic powder that is ground and bonded with a plastic, such as polyvinyl chloride (PVC), high-density polyethylene (HDPE) or polypropylene (PP). In some embodiments, the electrode comprises glassy carbon. The glassy carbon electrode may be a disposable electrode that can be readily and inexpensively replaced. In some embodiments, the glassy carbon electrode is a solid plate of glassy carbon. In other embodiments, the glassy carbon electrode is a polymer bonded or sintered electrode.

In some embodiments, the electrodes are coated with a stabilizing coating. In some embodiments, the stabilizing coating comprises titanium carbide, a titanium-carbon solid solution or suspension, titanium carbonitride, titanium oxycarbide, titanium oxynitride or titanium carbo-hydride. In some embodiments, the stabilizing coating is titanium carbide. In some embodiments, the titanium carbide coating is about 1-100 microns in thickness. In some embodiments, the titanium carbide coating has a Ti:C ratio of less than 2:1. Stabilizing coatings can be applied via physical vapor deposition (PVD), chemical vapor deposition (CVD), or other heat treatment in a reactive atmosphere or a reactive coating of the metal plate in an inert atmosphere.

The surface of the electrodes can additionally or alternatively be coated with a catalytic coating. In some embodiments, the catalytic coating may be coated on the electrodes near the inflow end of the destruction assembly, but not on the electrodes near the outflow end. For example, the first electrode of each stack, or the first 2-10 (e.g., 2, 3, 4, 5, 10) electrodes of each stack may have a catalytic coating. In some embodiments, the catalytic coating comprises a mixed metal oxide or transition metal. In some embodiments, the catalytic coating comprises manganese or any oxide thereof, silver or any oxide thereof, or a mixed silver-copper oxide. In some embodiments, the manganese or oxide thereof is doped manganese dioxide, a mixed manganese oxide, or doped manganese. In some embodiments, the silver or oxide thereof is AgO, Ag₂O, Ag₂O₃, or a higher oxide of silver, or a mixed or doped silver oxide. In some embodiments, the catalytic coating comprises a mixed silver-copper oxide. Without being bound by theory, it is believed that the materials of the catalytic coating attach the perfluoro compound in the chemical groups that allow water solubility, which may include carboxylic acid, alcohol, ether, amine, ammonium, sulfonate, or phosphonate groups, which initiates easier downstream destruction of the rest of the perfluoro compound.

### III. Electrochemical Destruction Method

In another aspect, provided herein is a method for destruction of an oxidizable or reducible compound. In some embodiments, the oxidizable or reducible compound is a perfluoro compound. The oxidizable or reducible compound (e.g., perfluoro compound) is present in an aqueous liquid. The method of the present invention is useful to destroy such contaminants present in an aqueous liquid. The present invention is also suitable to destroy oxidizable or reducible compounds in non-aqueous liquids.

The destruction method comprises flowing an aqueous liquid comprising a perfluoro compound (or other oxidizable or reducible compound) into a destruction assembly as described herein. For example, the aqueous liquid is flowed into a vessel, wherein the vessel houses a bipolar electrode assembly. The bipolar electrode assembly comprises a first electrode stack and second electrode stack, which form the boundaries of a tortuous path through the vessel. The method further comprises flowing the aqueous liquid through the vessel via the tortuous path and applying a voltage to the electrode assembly while the aqueous liquid flows through the tortuous path thereby destroying the perfluoro compound (or other oxidizable or reducible compound).

The method can be further illustrated with reference to FIG. 1A. Aqueous liquid comprising an oxidizable or reducible compound (e.g., a perfluoro compound) is flowed into the vessel as shown by the inlet arrow and flows around the electrodes via the tortuous path, e.g., zig-zag path. The aqueous liquid must flow laterally across the vessel along the electrode until it reaches an end of the electrode and then flow around the end of the electrode and then back in the opposite lateral direction to slowly advance longitudinally through the vessel. While the contaminated aqueous liquid flows through the vessel along the tortuous path, a voltage is applied to the bipolar electrode assembly. Specifically, voltage is applied to the end electrodes, e.g., end plates, of the first and second electrode stacks as shown. The method works analogously for the embodiments of FIGS. 2-5.

The voltage applied to the electrodes should be a high enough voltage to effectively destroy the perfluoro compounds (or other oxidizable or reducible compound) but without evolving gas. In some embodiments, electrode materials do not evolve gas even when the electrode voltage is above the decomposition voltage of the electrolyte solvent. In some embodiments, the corrosion current or electrochemical degradation current of the electrode material or electrode coating is less than 1 nanoamp per square centimeter of electrode area at a voltage significantly above the gas evolution potentials of the electrode materials. The voltage may be adjusted based on the conductivity of the aqueous liquid. As an example, voltage of from about 90 V to about 120 V DC or AC can be applied to a 50-plate bipolar electrode assembly.

A variety of oxidizable or reducible compounds may be destroyed via the present methods. In some embodiments, the oxidizable or reducible compound is any organic compound, inorganic compound, or ion thereof that undergoes oxidation or reduction when subjected to the electric field between at least one pair of charged electrodes of the bipolar electrode assembly. In some embodiments, the organic or inorganic compound has at least one polar functional group, a net ionic charge, or at least one non-trivial charged resonance form. In some embodiments, the oxidizable or reducible compound comprises an organic end with an ionic moiety. In some embodiments, the oxidizable or reducible compound is selected from the group consisting of a perfluoro compound, a borate, a phosphate, a polyphosphate, a sulfate, an organic acid, a fatty acid, a humic substance, a short chain PFAS, a water-soluble medication, a detergent, a water-soluble insecticide, a water-soluble fungicide, a water-soluble germicide, and any combination thereof. In some embodiments, the oxidizable or reducible compound is a perfluoro compound. In some embodiments, the perfluoro compound is PFOS, PFNA or PFOA or a conjugate base thereof. In some embodiments, the oxidizable or reducible compound is kerosene, toluene, methyl tert-butyl ether (MTBE), diesel fuel, dichloromethane, methylene chloride, a perchloro compound, or a polychlorinated biphenyl (PCB). In some embodiments, the oxidizable or reducible compound is a fabric dye, a pharmaceutical, or a petrochemical.

In some embodiments, the aqueous liquid comprises a sequestration agent. In methods of the present invention, the sequestration agent may be present in the aqueous liquid, or may be added to the aqueous liquid. When perfluoro compounds or other oxidizable or reducible compound are destructively oxidized or reduced to produce fluorine containing fragments, those fragments may form insoluble salts with the sequestration agent. In some embodiments, the sequestration agent is a counter ion. In some embodiments, the counter ion is a cation selected from Ca²⁺, Mg²⁺, Zn²⁺, Sr²⁺, Al³⁺, B³⁺, Al³⁺, or Fe³⁺. In some embodiments, the counter ion is Ca²⁺. In some embodiments, the counter ion is supplied to the aqueous liquid by addition of calcium hydroxide, calcium oxide, or calcium chloride to the aqueous liquid. In some embodiments, the aqueous liquid is basic and the source of Ca²⁺ is calcium hydroxide. In some embodiments, the aqueous liquid is acidic and the source of Ca²⁺ is calcium chloride. In some embodiments, the destruction method produces calcium fluoride.

In some embodiments, the counter ion is an anion selected from a phosphate, a sulfate, or a borate. In some embodiments the counter ion is supplied to the aqueous liquid by addition of calcium phosphate, calcium borate, calcium sulphate, magnesium phosphate, magnesium borate, or magnesium sulphate to the aqueous liquid.

In some embodiments, prior to destruction, the pH of the aqueous liquid is modulated to aid precipitation of bound sequestration agent. For example, lime or other hydroxide can be added to the aqueous liquid to change the pH. Carbon dioxide, bicarbonate, phosphoric acid, and sulfuric acid may also be used as pH modulating agents. pH modulation may be accomplished with a lime wash by bubbling carbon dioxide or adding bicarbonate; this lowers the pH from the Ca(OH)₂ solution to a neutral or near neutral pH and improves the aggregate size of the precipitate by co-precipitating calcium carbonate. Alternatively, phosphoric acid and sulfuric acid may also be introduced to form salts with calcium and act as neutralizing agents.

In some embodiments, the aqueous liquid comprises untreated contaminated aqueous mixture. In some embodiments, the aqueous liquid comprises a C₁₋₅ alcohol. In some embodiments, the aqueous liquid further comprises ozone. In some embodiments, the aqueous liquid has a low conductivity.

In some embodiments, the aqueous liquid further comprises an antifreeze agent that lowers the freezing point of the aqueous liquid. In some embodiments, the antifreeze agent is selected from the group consisting of propylene glycol, polypropylene glycol, polyethylene glycol, glycerol, polyvinyl alcohol, carboxymethylcellulose, ribose, sucrose, glucose, rhamnose, xylose, fructose, raffinose, stachyose, low molecular weight hydroxyethyl starches, maltodextrin, cellodextrins, and any mixture thereof. In some embodiments, the aqueous liquid comprises from about 0.1 wt % to about 20 wt % of the antifreeze agent (e.g., about 1 to about 10 wt % of the antifreeze agent). In some embodiments, the freezing point of the aqueous liquid is below about −0.3° C. In some embodiments, the antifreeze agent encourages slush formation of the aqueous liquid at freezing temperatures.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A destruction assembly for destroying an oxidizable or reducible compound comprising a vessel that houses a bipolar electrode assembly, the bipolar electrode assembly comprising a first electrode stack and second electrode stack, the first electrode stack comprising a first plurality of electrodes and the second electrode stack comprising a second plurality of electrodes, wherein the electrodes span laterally across at least a portion of the vessel, and wherein the electrodes define the boundaries of a tortuous path through the vessel.

2. The assembly of claim 1, wherein the bipolar electrode assembly comprises metal electrodes comprising a metal selected from titanium, aluminum, steel, low-chromium steel, cast-iron, nickel, cobalt, chromium, or any alloy thereof.

3. The assembly of claim 1, wherein the bipolar electrode assembly comprises ceramic electrodes.

4. The assembly of claim 1, wherein the bipolar electrode assembly comprises electrodes coated with titanium carbide, a titanium-carbon solid solution or suspension, titanium carbonitride, titanium oxycarbide, titanium oxynitride or titanium carbo-hydride.

5. The assembly of claim 4, wherein the bipolar electrode assembly comprises electrodes coated with titanium carbide.

6. The assembly of claim 5, wherein the titanium carbide has a Ti:C ratio of less than 2:1.

7. The assembly of claim 4, wherein the coating is from about 1 to about 100 microns thick.

8. The assembly of claim 1, wherein at least a portion of the bipolar electrode assembly is coated with a catalytic coating.

9. The assembly of claim 8, wherein the catalytic coating comprises a mixed metal oxide or transition metal.

10. The assembly of claim 8, wherein the catalytic coating comprises manganese or any oxide thereof, silver or any oxide thereof, or a mixed silver-copper oxide.

11. The assembly of claim 1, wherein the electrodes are rigid plates.

12. The assembly of claim 1, wherein the bipolar electrode assembly comprises glassy carbon electrodes.

13. The assembly of claim 1, wherein first electrode stack and second electrode stack each comprise at least three electrodes.

14. The assembly of claim 1, wherein the electrodes extend laterally across the vessel and are perforated in an offset and alternating manner.

15. The assembly of claim 1, wherein the electrodes extend from a wall of the vessel laterally more than half-way across the vessel.

16. The assembly of claim 15, wherein the first plurality of electrodes extend from a first wall of the vessel laterally more than half-way across the vessel and the second plurality of electrodes extend from a second wall of the vessel laterally more than half-way across the vessel and are offset from and alternate with the first plurality of electrodes to define the boundaries of a tortuous path through the vessel.

17. The assembly of claim 1, wherein the first plurality of electrodes is oriented substantially parallel to the second plurality of electrodes.

18. The assembly of claim 1, further comprising a central support member extending longitudinally through the inside of the vessel, wherein the first plurality of electrodes are joined to and supported by a vessel wall and the second plurality of electrodes are joined to and supported by the central support member.

19. The assembly of claim 18, wherein the first plurality of electrodes extend laterally inward from a wall of the vessel toward the central support member and the second plurality of electrodes extend laterally outward from the central support member.

20. The assembly of claim 1, wherein the vessel has a rectangular cross section and the electrodes are rectangle-shaped.

21. The assembly of claim 1, wherein the vessel has a round cross section and the electrodes are disc-shaped.

22. A destruction system for destroying an oxidizable or reducible compound comprising the assembly of claim 1 and a power source electrically connected to the bipolar electrode assembly and configured to apply a voltage to the bipolar electrode assembly.

23. The system of claim 22, wherein the power source is directly electrically connected to the end electrodes of the bipolar electrode assembly.

24. A method for destroying an oxidizable or reducible compound comprising:
flowing an aqueous liquid comprising an oxidizable or reducible compound into a vessel that houses a bipolar electrode assembly, the bipolar electrode assembly comprising a first electrode stack and second electrode stack, the first electrode stack comprising a first plurality of electrodes and the second electrode stack comprising a second plurality of electrodes, wherein the electrodes span laterally across at least a portion of the vessel, and wherein the electrodes define the boundaries of a tortuous path through the vessel;
flowing the aqueous liquid through the vessel via the tortuous path; and
applying a voltage to the bipolar electrode assembly while the aqueous liquid flows through the tortuous path to destroy the oxidizable or reducible compound.

25. The method of claim 24, wherein the aqueous liquid further comprises a counter ion that is bound to the oxidizable or reducible compound.

26. The method of claim 25, wherein the counter ion is a cation selected from Ca²⁺, Mg²⁺, Zn²⁺, Sr²⁺, Al³⁺, B^{3+,} or Fe³⁺.

27. The method of claim 26, wherein the counter ion is Ca²⁺.

28. The method of claim 24, wherein the aqueous liquid comprises calcium hydroxide.

29. The method of claim 24, wherein the aqueous liquid comprises a chloride, hydroxide or sulfate of Ca²⁺, Mg²⁺, Zn²⁺, Sr²⁺, Al³⁺, B³⁺, or Fe³⁺.

30. The method of claim 25, wherein the counter ion is an anion selected from a phosphate, a sulfate, or a borate.

31. The method of claim 24, wherein the aqueous liquid further comprises ozone.

32. The method of claim 24, comprising applying a voltage of from about 90 V to about 120 V to the bipolar electrode assembly.

33. The method of claim 24, wherein the oxidizable or reducible compound is a perfluoro compound.

34. The method of claim 33, wherein the perfluoro compound is destructively oxidized and/or destructively reduced to produce fluorine containing fragments.

35. The method of claim 34, wherein the fluorine containing fragments form insoluble salts with a counter ion present in the aqueous liquid.

36. The method of claim 35, wherein the fluorine containing fragments form insoluble salts with calcium ions present in the aqueous liquid.

37. The method of claim 24, wherein the voltage is applied directly to end plates of the bipolar electrode assembly.

38. The method of claim 24, wherein the voltage applied directly to the end plates of the bipolar electrode assembly is isolated from ground.

39. The method of claim 24, wherein the oxidizable or reducible compound is an organic compound, inorganic compound, or ion thereof.

40. The method of claim 39, wherein the oxidizable or reducible compound is kerosene, toluene, or methyl tert-butyl ether (MTBE).

41. The method of claim 39, wherein the oxidizable or reducible compound is a borate, a phosphate, a polyphosphate, a sulfate, an organic acid, a fatty acid, a humic substance, a short chain PFAS, a water-soluble medication, a detergent, a water-soluble insecticide, a water-soluble fungicide, or a water-soluble germicide.

42. The method of claim 24, wherein the aqueous liquid comprises a perfluoro compound and a second oxidizable or reducible compound, and wherein both the perfluoro compound and the second oxidizable or reducible compound are destroyed.

43. The method of claim 42, wherein the second oxidizable or reducible compound is a fabric dye, a pharmaceutical, or a petrochemical.

44. The method of claim 33, wherein the perfluoro compound is PFOS, PFNA, PFOA, or a conjugate base thereof.
